(19) United States
(12) Patent Application Publication
(10) Pub. No.: US 2006/0262913 A1
(43) Pub. Date: Nov. 23, 2006

(54) Method and system of providing caller ID messaging

(76) Inventors: Michael J. Cook, Flemington, NJ (US); Jason D. Livingood, Philadelphia, PA (US); Jason Gaedtke, Evergreen, CO (US); James C. Draper, Ft. Washington, PA (US)

Correspondence Address: BROOKS KUSHMAN P.C., 1000 TOWN CENTER, TWENTY-SECOND FLOOR, SOUTHFIELD, MI, 48075, US

(21) Appl. No.: 11/132,963

(22) Filed: May 19, 2005

(51) Int. Cl. H04M 1/64

(52) U.S. Cl. 379/88.19

(57) ABSTRACT

A method and system of providing caller ID messaging. The caller ID messaging being of the type used to alert subscribers of incoming phone calls, such as through displays, audio alerts, or other features.

### BACKGROUND OF THE INVENTION

1. Field of the Invention

The present invention relates to methods and systems of providing caller ID messaging.

2. Background Art

Settop boxes (STBs) and other media units may be configured to receive signals from media providers and to playback the received media signals on televisions and other media output devices. The media signals may be delivered through any number of mediums, such as cable, wireless, and the like. The medium and signals associated therewith may be generally characterized as a media feed.

For caller ID applications, it is known to overlay caller ID messages with the media signals so as to force playback of the caller ID messages on televisions and other media output devices associated with the media unit. A caller ID unit may be configured to overlay or otherwise interlace the caller ID messages with the media feed. The television is thereby force to display the caller ID messages with playback of the media.

One known caller ID unit interfaces between a telephone line and the media feed to capture caller ID information from the telephone line. The unit then generates a caller ID message and overlays onto the media feed and upstream from the media unit. Because the caller ID messages are overlaid with other media signals, the media unit is unable to distinguish the caller ID messaging signals from non-caller ID messaging signals. This forces the media unit to slavishly playback the caller ID messages with playback of the media.

The overlaid caller ID messages are problematic because they may be carried through to all applications associated with the media unit. For example, if the media unit converts or otherwise manipulates the media feed for transmission to a recorder, all images recorded by the recorder will include the overlaid call ID messages. As such, if a user later replays the recorded media, caller ID images from a previous time will playback with the recorded media.

### SUMMARY OF THE INVENTION

One non-limiting aspect of the present invention relates to providing caller ID messaging services without overlaying caller ID related messages in a media feed.

One aspect of the present invention relates to a system of providing caller ID messaging in a cable network wherein a settop box (STB) is configured to output cable television signals to a television for playback. The system may include a unit configured for interrogating incoming phone calls, the unit configured to generate caller ID messages as a function thereof, the caller ID messages including features for displaying calling party information on the television, the unit configured to transport caller ID messaging signals associated with the caller ID messages to the STB in non-overlaid fashion, the STB being configured to distinguish the caller ID messaging signals from non-caller ID messaging signals and to output the caller ID messaging signals to the television for displaying the caller ID message associated therewith.

In accordance with one non-limiting aspect of the present invention, the unit may be a call management unit configured to transport the caller ID messaging signals over the cable network. The call management unit may be configured to interrogate phone calls originating over a PSTN or VoIP network and to generate the caller ID messages as function thereof.

In accordance with one non-limiting aspect of the present invention, the unit may be a caller ID transmitter having an interface for connecting to a telephone line. The caller ID transmitter may be configured to communicate wireless signals to the STB to facilitate display of the caller ID messages.

One aspect of the present invention relates to a method of providing caller ID messaging. The method may include interrogating a phone call, generating caller ID messaging signals for providing a caller ID message related to the phone call, transporting the caller ID messaging signals in a non-overlaid fashion to a media unit, and transporting the caller ID messaging signals from the media unit for playback on a media output device.

In accordance with one non-limiting aspect of the present invention, the method may including providing caller ID messaging for PSTN or VoIP based phone calls. The calls may be routed through a cable network or over the PSTN. The caller ID messaging signals may be communicated from a network based call management unit and/or from a subscriber based caller ID transmitter.

One aspect of the present invention relates to a method of providing caller ID messaging with a media unit configured to output media signals to a media output device. The method may include receiving caller ID messaging signals with the media unit, receiving media signals with the media unit, and configuring the media unit to distinguish between the caller ID messaging signals and the media signals such that the media unit is capable of outputting one or both of the media signals and the caller ID messaging signals to the media device.

One aspect of the present invention relates to a system of providing caller ID messaging. The system may include a media unit configured to receive caller ID messaging signals and media signals, wherein the media unit is configured to distinguish between the caller ID messaging signals and the media signals such that the media unit may output one or both of the media signals and the caller ID messaging signals. The system may further include a media output device in communication with the media unit and configured to playback the media signals and caller ID messaging signals outputted from the media unit.

The above features and advantages, along with other features and advantages of the present invention, are readily apparent from the following detailed description of the invention when taken in connection with the accompanying drawings.

### BRIEF DESCRIPTION OF THE DRAWINGS

FIG. 1 illustrates a network based system of providing caller ID messaging in accordance with one non-limiting aspect of the present invention; and

FIG. 2 illustrates a transmitter based system of providing caller ID messaging in accordance with one non-limiting aspect of the present invention.

### DETAILED DESCRIPTION OF THE PREFERRED EMBODIMENT(S)

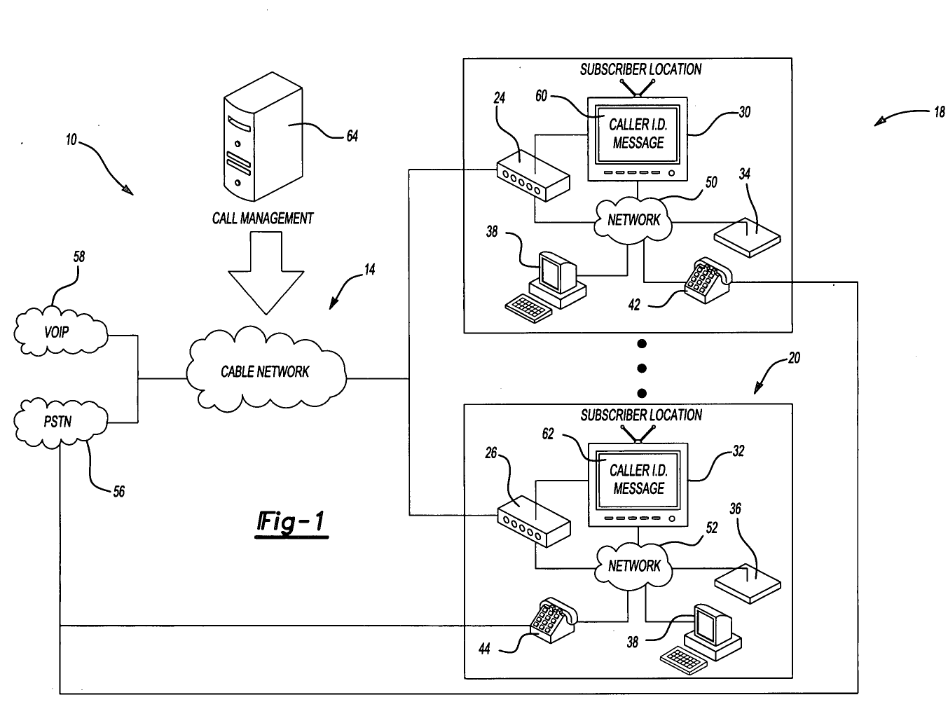

FIG. 1 illustrates a network based system 10 of providing caller ID messaging in accordance with one non-limiting aspect of the present invention. The system 10 may include a cable network 14 configured to provide services to one or more subscriber locations 18-20. The system 10 may be configured to support any number of services, including cable television, high-speed data applications, audio and video streaming, voice over internet protocol (VoIP) call routing, telephone call routing, and other media related applications.

The cable network 14 may include any number of features and components for supporting the various subscriber services, including a session boarder controller, a media gateway, a media gateway controller, a signaling gateway, a call management server, a presence server, a SIP routing proxy, a SIP proxy/registrar server, a PCMM cable modem termination system (CMTS), a PCMM policy server, a bandwidth on demand server, a streaming server caching proxy, a gaming server, a CDN, a media acquisition server, a provider (comcast.net) server, a unified messaging server, a SIP feature server, a OSS/BSS, and a global directory server.

Each subscriber location 18-20 may include media units 24-26 for interfacing with the cable network 14. The media units 24-26 may be configured to support any number of applications and features to facilitate communications with the cable network 14. The media units 24-26 may be configured to decrypt proprietary signaling encryption associated with communicating over the cable network. The media units 24-26 may include any number of configurations and features, including configurations and features associated with settop box (STBs), cable modems, wireless termination points, media terminal adapters (MTAs), outlet digital adapters (ODAs), or other devices.

Each subscriber location 18-20 may include a media output or interface device. The media output devices are generally characterized as devices having features for interacting with the subscribers. The present invention contemplates each subscriber location having any number of different types of media devices. For exemplary purposes, each subscriber location is shown to include a television 30-32, media recorder 34-36, computer 38-40, and telephone 42-44 (which may be a VoIP or dual function phone).

Because of encryption settings and other parameters attendant to signals communicated from the cable network 14, the media units 24-26 may be required to process all signals exchanged between the media output devices 30-44 and the network 14. Each subscriber location 18-20 is shown to include a single standalone media unit 24-26 for this purpose. The other subscriber devices 30-44 may communicate with the media units 24-26 directly or over a subscriber location (in-home) network 50-52. The present invention contemplates any number of other configurations for supporting communications between the cable network 14 and the media output devices 30-44, including the use of multiple media units and/or integrating operations and features associated with the media unit into one or more of the media output devices 30-44.

The system 10 may include a public telephone switching network 56 (PSTN). The PSTN 56 may be connected to the telephones 42-44 to facilitate telephone communications with one or more of the subscriber locations 18-20. The system may further include a VoIP network 58. The VoIP network 58 may be configured to communicate IP related telephone calls with the cable network 14. The cable network 14 may be configured to then route the calls to the subscriber locations 18-20. The cable network 14 may be configured with addressing applications and other features for supporting VoIP operations.

In accordance with one non-limiting aspect of the present invention, the system may include a call management unit 64. The call management unit 64 may be configured for alerting the subscribers of incoming calls. It may be configured to locate or otherwise discover incoming calls originating from either of the PSTN 56 or VoIP network 58.

The call management unit 64 may be configured to interrogate the calls to determine information associated with a party making the call (calling party). For example, the call management unit 64 may be configured to determine a calling party phone number, name, location, and other identifying information. The call management unit may then use the calling party information in generating a caller ID message.

The call management unit 64 may include any number of configurations and features for determining the calling parity information. It may be configured to query caller ID information from external caller ID databases and systems or it may include its own caller ID databases and system. It may cross-reference or otherwise look-up the calling party information in tables or other memory based applications.

The caller ID message may include a graphic (logo, icon), alphanumeric, or other multimedia display or representation of the calling party information. The call management unit 64 may be configured to generate instructions, commands, or other signals for communicating the caller ID message to the media units 24-26. The media units 24-26 may be configured to convert, manipulate, or otherwise format the received caller ID signals to signals suitable for displaying or otherwise outputting the caller ID message to one or more of the media output devices 30-44, such as to display caller ID messages 60-62 on the televisions 30-32.

Of course, the present invention contemplates any number of configurations and arrangements of formatting the caller ID messages for output on one or more of the media output devices 30-44 and is not intended to be limited to the foregoing. The present invention, in particular, contemplates applications where the call management unit 64 transports caller ID messaging signals directly to the media output devices 30-44 and without having to route, decrypt, or otherwise manipulate the signals with the media units 24-26.

The call management unit 64 may be configured to deliver the caller ID messaging signals to the media units 24-26 in advance of the telephone call reaching the subscriber locations 18-20. Preferably, the caller ID messaging signals reach the subscribers before the arrival of the telephone call so that the subscribers may be alerted of the incoming call prior to the phone ringing. The cable network 14 may include features for pausing or otherwise delaying transmission of incoming calls to the subscriber locations 18-20 in order to insure the caller ID messages are provided before the phone rings.

The call management unit 64 may include features for transporting or otherwise downloading software, configuration images, or other logic to the media units 24-26 or media output devices 30-44. The downloaded information may include commands and other features for instructing display of the caller ID messages. The media units 24-26 may be configured or instructed to convert, manipulate, or otherwise format the received caller ID signals to signals suitable for displaying or otherwise outputting the caller ID message to one or more of the media output devices.

The call management unit 64 may be configured to route calls originating over the PSTN 56 or VoIP network 58 to the subscriber locations 18-20. It may include addressing information and other features to facilitate such operations. A database or other feature may be used by the call management unit 64 to cross-reference or otherwise associate incoming calls with one or more the subscribes so as to facilitating the routing of the calls thereto.

The cable network 14 may include servers, switches, routers, or other features for facilitating interactions with the VoIP network 58 and PSTN 56. The network 14 may include a PSTN telephone conversion unit (not show). The conversion unit may be configured to covert PSTN originated calls into VoIP calls so that the converted calls may be transferred over the network 14. Such capabilities, however, are not required to support caller ID messaging as the present invention contemplates the call management unit 64 generating caller ID messages for PSTN based calls which are not routed through the cable network 14.

In accordance with one non-limiting aspect of the present invention, the media units 24-26 may be STBs configured to output signals to the televisions 30-32 and/or the media recorders 34-36. Preferably, the caller ID messaging signals are communicated to the STB in a non-overlaid fashion. The non-overlaid signals are preferably characterized by the ability of the STB to distinguish the caller ID messaging signals from media signals carried in the same media feed.

The call management unit 64 may be configure to format or otherwise configure the call ID messaging signals for transportation to the media units 24-26. The signals are preferably configured so that the media units 24-26 may distinguish the caller ID messaging signals from other media or non-caller ID signals. The present invention contemplates communicating the caller ID messaging signals to the media units 24-26 through out-of-band (OOB) messaging, through IP based in-band messaging which utilizes a data portion of a video feed, and other proprietary messaging which may be particular to the media units 24-26, i.e., its manufacturer, model, etc.

The media units 24-26 may be configured to selectively control outputting of the caller ID messages. For example, they may be configured to output the caller ID messages to the televisions 30-32 while simultaneously preventing the caller ID messages from reaching the media recorders 34-36, which eliminates the problem of recording the caller ID messages over the recorded media.

The present invention contemplates other means for displaying, audibilizing, or otherwise communicating an alert to the subscriber of the incoming telephone call, including audibilizing caller ID messages for playback through television speaker or stereo speakers. Of course, the present invention contemplates any number of applications for alerting the subscriber of the incoming call, including multi-media alerts having audio, video, and data components or combinations thereof.

The present invention contemplates any number of features and configurations for the caller ID messages. The messages may include calling party identifiers as well as other information, such as logos, advertisements, and the like. The present invention contemplates displaying the caller ID messages through user interfaces or other mediums so as to provide interactive phone features, such a features for routing the incoming call to voice-mail and the like.

For example, if the telephone call is routed through the cable network 14, the call management unit 64 may receive a request from the subscriber for forwarding the call to voicemail. The call management unit 64 may interface with other features associated with routing the call so as to instruct those features to forward the call to voicemail. Likewise, traffic and billing information may be collected by the call management unit according to the number of caller ID messages displayed, number of caller ID messages forwarded to voicemail, and any number of other parameters, such as for use in billing customers, providers, and advertisers.

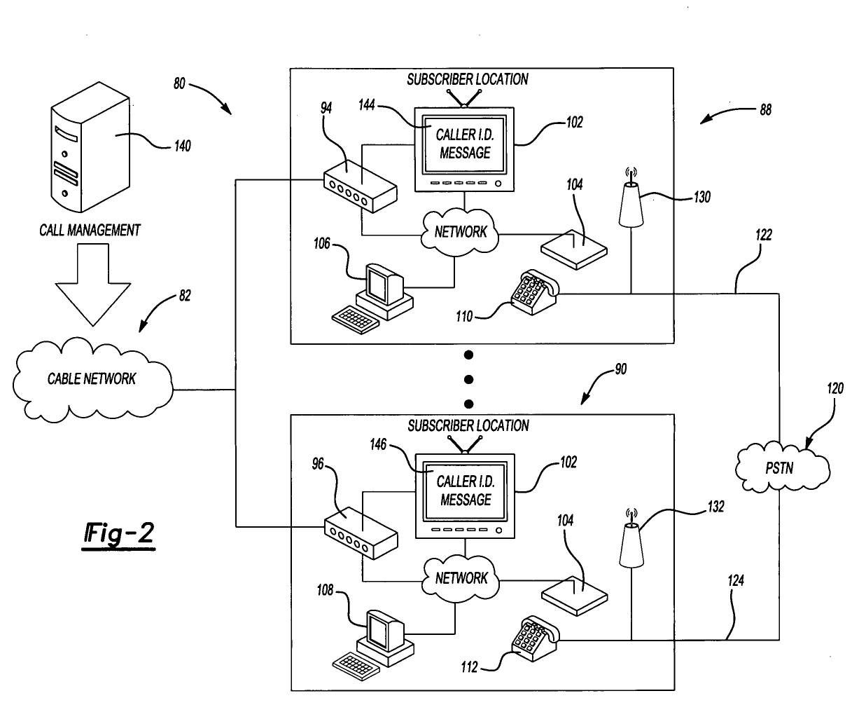

FIG. 2 illustrates a transmitter based system 80 of providing caller ID messaging in accordance with one non-limiting aspect of the present invention. The system 80 may include a cable network 84 configured to provided services to one or more subscriber locations 88-90. The system 80 may be configured to support any number of services, including cable television, high-speed data applications, audio and video streaming, voice over internet protocol (VoIP) call routing, telephone call routing, and other media related applications.

The cable network 14 may include any number of features and components for supporting a variety of subscriber services, including the features described above with respect to the network based system. Each subscriber location 88-90 may include media units 94-96 and media output devices 100-112, such as settop box (STBs), cable modems, wireless termination points, media terminal adapters (MTAs), outlet digital adapters (ODAs), televisions, media recorders, computers, and telephones (which may be a VoIP or dual function phone), and any number of other units and devices.

The system may include a public telephone switching network (PSTN) 120 for exchanging telephone calls with the subscriber telephones 110-112. One or more telephones at the subscriber locations 88-90 may ring in response to incoming calls. Individuals at the subscriber locations 88-90 may answer the call by picking up the telephone and establishing a connection with the PSTN 120 by way of telephone lines 122-124 connected thereto.

In accordance with one non-limiting aspect of the present invention, the system 80 may include caller ID transmitters 130-132 for alerting the subscribers of incoming calls. The caller ID transmitters 130-132 may be configured to receive telephone signals from the subscriber telephone lines 122-124 and to transmit caller ID messaging signals to the media units 94-96 and/or directly to the one or more media devices 100-112.

The caller ID transmitters 130-132 may include a memory, microprocessor, and other features for providing the caller ID messaging signals. The caller ID transmitters 130-132 may be configured to interrogate the calls to determine information associated with a party making the call (calling party). For example, the caller ID transmitters 130-132 may be configured to determine a calling party phone number, name, location, and other identifying information. The caller ID transmitters 130-132 may then use the calling party information in generating a caller ID message.

The caller ID transmitters 130-132 may include any number of configurations and features for determining the calling parity information. It may be configured to query caller ID information from external caller ID databases and systems or it may include its own caller ID databases and system. It may cross-reference or otherwise look-up the calling party information in tables or other memory based applications.

The caller ID transmitters 130-132 may include an RJ11 interface for connecting to the subscriber telephone line and an infrared (IR) or radio frequency (RF) transmitter for transmitting caller ID messaging signals. Of course, the present invention contemplates any number of other means for communicating the caller ID messaging signals, including proprietary interfaces created through Infrared, Serial Connections, USB Connections, Firewire Connections (IEEE-1394), or other wired or wireless interface methods.

The caller ID transmitters 130-132 may be configured to format or otherwise generate caller ID messaging signals to support the playback of the caller ID messages. The signals are preferably configured so that the receiving device, whether it be the media units 94-96 or one of the media devices 100-112, may distinguish the caller ID messaging signals from other media or non-caller ID signals transported thereto.

The caller ID messaging signals may be defined according to remote control protocols used by a remote control (not shown) to control operation of the media unit. The present invention contemplates the use of standard media unit components to receive the caller ID messaging signals from the transmitters 130-132. The caller ID transmitters 130-132 may be a plug-and-play type device that operates with legacy media units and existing technology.

A call management unit 140 may be included within the cable network 82 to support the caller ID messaging. The call management unit 140 may include features for transporting or otherwise downloading software, configuration images, or other logic to the media units 94-96 or media output devices 100-112. The downloaded information may include commands and other features for instructing display of the caller ID messages. The media units 94-96 may be configured or instructed to convert, manipulate, or otherwise format the received caller ID signals to signals suitable for displaying or otherwise outputting the caller ID message to one or more of the media output devices.

The caller ID messages associated with the caller ID transmitters 130-132 may be similar to the above-described caller ID messages. The caller ID transmitters 130-132 may be configured to support alerting user(s) of the media output devices of incoming calls prior to or simultaneously with the calls being routed to the subscriber's telephone. The present invention contemplates displaying, audibilizing, or otherwise communicating an alert to the subscriber of the incoming telephone call, such as by displaying caller ID messages 144-146 on the televisions 100-102. Of course, the present invention contemplates any number of applications for alerting the subscriber of the incoming call, including multi-media alerts having audio, video, and data components or combinations thereof.

The present invention contemplates any number of features and configurations for the caller ID messages. For example, the messages may include calling party identifiers as well as other information, such as logos, advertisements, and the like. In particular, the present invention contemplates displaying the caller ID messages through user interfaces or other mediums so as to provide interactive features, such a features for routing the incoming call to voice-mail and the like.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of providing caller ID messaging with a media unit configured to output media signals to a media output device, the method comprising:
receiving caller ID messaging signals with the media unit;
receiving media signals with the media unit; and
configuring the media unit to distinguish between the caller ID messaging signals and the media signals such that the media unit is capable of outputting one or both of the media signals and the caller ID messaging signals to the media device.

2. The method of claim 1 further comprising:
receiving the caller ID messaging signals from a transmitter connected to a telephone line, the transmitter receiving caller ID information from the telephone line and outputting the caller ID messaging signals to the media unit as a function thereof.

3. The method of claim 2 further comprising:
outputting the caller ID messaging signals from the transmitter through infrared (IR) signaling.

4. The method of claim 2 further comprising:
outputting the caller ID messaging signals from the transmitter through radio frequency (RF) signaling.

5. The method of claim 1 further comprising:
receiving the caller ID messaging signals from a cable system associated with the media unit, the cable system providing the caller ID messaging signals and media signals to the media unit through a media feed.

6. The method of claim 5 further comprising:
receiving the caller ID messaging signals from the cable system through out-of-band portions of the media feed.

7. The method of claim 5 further comprising:
receiving the caller ID messaging signals from the cable system through in-band data portions of the media feed.

8. A system of providing caller ID messaging, the system comprising:
a media unit configured to receive caller ID messaging signals and media signals, wherein the media unit is configured to distinguish between the caller ID messaging signals and the media signals such that the media unit may output one or both of the media signals and the caller ID messaging signals; and
a media output device in communication with the media unit and configured to playback the media signals and caller ID messaging signals outputted from the media unit.

9. The system of claim 8 further comprising:
a transmitter configured to connect to a telephone line and to output the caller ID messaging signals to the media unit as a function of signals received through the telephone line.

10. The system of claim 9 wherein the transmitter is configured to output the caller ID messaging signals through infrared (IR) signaling.

11. The system of claim 9 wherein the transmitter is configured to output the caller ID messaging signals through radio frequency (RF) signaling.

12. The system of claim 8 further comprising:
a media content provider configured to provide a media feed to the media unit, the media feed including the caller ID messaging signals and the media signals.

13. The system of claim 12 wherein the media content provider is configured to provide the caller ID messaging signals through out-of-band portions of the media feed.

14. The system of claim 12 wherein the media content provider is configured to provide the caller ID messaging signals through in-band data portions of the media feed.

15. A method of providing caller ID messaging, the method comprising:
interrogating a phone call;
generating caller ID messaging signals for providing a caller ID message related to the phone call;
transporting the caller ID messaging signals in a non-overlaid fashion to a media unit; and
transporting the caller ID messaging signals from the media unit for playback on a media output device.

16. The method of claim 15 further comprising:
interrogating the phone call based on signals received from a PSTN.

17. The method of claim 16 further comprising:
routing the PSTN based phone call through a cable network to a subscriber location associated therewith.

18. The method of claim 15 further comprising:
interrogating the phone call based on VoIP signals received from a VoIP network.

19. The method of claim 18 further comprising:
routing the VoIP based phone call through a cable network to a subscriber location associated therewith.

20. The method of claim 15 further comprising:
displaying the caller ID message in an interactive user interface, the interactive user interface including interactive phone features for controlling termination of the phone call.

21. The method of claim 20 further comprising:
forwarding the phone call to voicemail through as a function of inputs received through the interactive user interface.

22. A system of providing caller ID messaging in a cable network wherein a settop box (STB) is configured to output cable television signals to a television for playback, the system comprising:
a unit configured for interrogating incoming phone calls, the unit configured to generate caller ID messages as a function thereof, the caller ID messages including features for displaying calling party information on the television, the unit configured to transport caller ID messaging signals associated with the caller ID messages to the STB in non-overlaid fashion, the STB being configured to distinguish the caller ID messaging signals from non-caller ID messaging signals and to output the caller ID messaging signals to the television for displaying the caller ID message associated therewith.

23. The system of claim 22 wherein the unit is a call management unit configured to transport the caller ID messaging signals over the cable network.

24. The system of claim 23 wherein the call management unit is configured to interrogate phone calls originating over a PSTN or VoIP network and to generate the caller ID messages as function thereof.

25. The system of claim 22 wherein the unit is a caller ID transmitter having an interface for connecting to a telephone line.

26. The system of claim 25 wherein the caller ID transmitter communicates wireless signals to the STB to facilitate display of the caller ID messages.

27. The system of claim 25 wherein the caller ID transmitter communicates signals over an in-home network to STB to facilitate display of the caller ID messages.

28. The system of claim 25 wherein the caller ID transmitter includes an RJ-11 interface.

29. The system of claim 22 wherein the STB is configured to output the cable television signals to a recorder without including the caller ID messaging signals therewith.
